(19) United States
(12) Patent Application Publication
(10) Pub. No.: US 2019/0378113 A1
(43) Pub. Date: Dec. 12, 2019

(54) TRANSACTION SECURITY SYSTEM

(71) Applicant: Lennard D. Castillo, Seattle, WA (US)

(72) Inventor: Lennard D. Castillo, Seattle, WA (US)

(21) Appl. No.: 16/128,354

(22) Filed: Sep. 11, 2018

Related U.S. Application Data
(60) Provisional application No. 62/556,943, filed on Sep. 11, 2017.

(51) Int. Cl. G06Q 20/32; H04N 7/18; H04L 12/58

(52) U.S. Cl. CPC G06Q 20/3224; H04L 51/046; H04N 7/185

(57) ABSTRACT

A system for managing a transaction. The system receives a transaction description that identifies the parties to the transaction and time and location of the transaction. The system tracks the locations of the parties to the transaction starting prior to the time of the transaction and ending after the transaction has been completed. The system provides to each party an indication of tracked locations of at least one other party to the transaction so that a party may know the tracked location of another party. The system receives from a party an indication that the transaction is complete. The system records an indication that the transaction is complete.

This application claims the benefit of and priority to U.S. Provisional Patent Application No. 62/556,943, filed Sep. 11, 2017, incorporated herein by reference in its entirety.

A method and system for providing security for a transaction involving multiple parties are provided. In some embodiments, a transaction security system (“TSS”) manages a transaction involving parties to help ensure the security of the parties. The TSS may receiving a transaction description based on an advertisement placed with an advertisement service in which a party has placed an advertisement offering to conduct a transaction. The transaction description may include names of the parties, time and location of the transaction, type of transaction, method of payment, and so on. The advertisement service may be a classified advertisement service such as Craigslist. The advertisement service may offer the parties to a transaction the option of enabling security for the transaction. Alternatively, the TSS may allow the parties to a transaction to register for security independently of which advertisement service through which the advertisement was placed. When security is enabled for a transaction, the TSS provides information to the parties (e.g., via an application executing on a mobile device of the parties) such as the locations of parties relating to their arrival at and departure from the location of the transaction at the time of the transaction. The location information can be useful to help ensure that a party recognizes another party. For example, if the location of the transaction is at a fountain at a public park, then each party would know when the other party has arrived and when to attempt identifying the other party. The TSS may provide the locations of the parties to a mobile device of each party for display on a map centered on the location of the transaction.

In some embodiments, the parties to a transaction may request that the transaction be monitored by a monitor. A monitor may be a person who is available to attend the transaction in person or attend remotely by monitoring a video stream of the transaction. For example, a monitor may be an off-duty police officer, a driver for a transportation company (e.g., Lyft or Uber), and so on. The TSS may provide a service for people to register to act as monitors. When a person registers, the TSS may coordinate a background check on the person (e.g., employment verification, criminal record check, and firearms registrations) to ensure that the person has the desired qualifications to be a monitor. If a monitor is requested, the TSS may also provide location tracking for the monitor who may be considered to be a party to the transaction.

In some embodiments, the TSS may only provide the locations a party to another party when that party is within an awareness zone that encompasses the location of the transaction. For example, the awareness zone may be defined by a certain radius (e.g., 100 meters) of the location of the transaction. The shape and size of the awareness zone may also be set as agreed upon by the parties. The use of an awareness zone may help ensure security of the transaction by not providing information as the location of a party prior to entering the awareness zone. The TSS may track the location of the parties well prior to entering to the awareness zone and provide an estimated time of arrival even without providing the actual location information of one party to another party.

Also, if the location of a party cannot be tracked or tracking is lost, the TSS may notify the other parties and not provide the locations of the other parties to the party that cannot be tracked. This will allow the other parties to travel without being tracked by a party who may have intentionally disabled their own tracking. If the transaction includes a monitor, then the TSS may only provide to the other parties the location of the monitor until the monitor arrives at the location of the transaction. The TSS may also provide a messaging service so the parties can send messages (e.g., text or audio) to each other prior to arrival at the location of the transaction.

After the monitor has arrived, the TSS may then provide the location of each party to the other parties. The TSS may track the locations of the parties after the transaction is complete to help ensure that one party is not following another party. Also, if a party is near another party prior to arriving at the location, the TSS may not provide the locations to the parties and may notify the parties who may decide for security reasons not go through with the transaction. The TSS may provide a “panic button” on the mobile device of a party, which a party can press if they feel that their security is in jeopardy. In response to the pressing of the panic button, a message may be sent to a 911 dispatcher, a police department, or some other security service. Also, the volume on the mobile device may be set to loud and a siren-type sound may be played to get the attention of others who may be nearby and can render assistance.

In some embodiment, the TSS may verify the identity of the parties prior to the transaction being conducted and may perform background checks. The TSS may provide a photograph of a party to the other party to help with recognition at the time of the transaction. The TSS may also obtain additional security information such as biometric information (e.g., fingerprints collected by a device of the party) to help police identify a party as necessary. The TSS may also provide an option for the parties to stream of video of the transaction from their mobile device to the TSS as a record of the transaction. A party may have multiple mobile devices with one positioned to collect and stream the video while the other is used to enable payment, view photo of the parties, record completion of the transaction, and so on. After a transaction is complete, the TSS may request the parties to rate the other parties to the transaction (e.g., from 1 to 5). The TSS may use the rating to generate a reputation score for the parties and may present reputation scores (e.g., as 1 to 5 stars) to assist parties in deciding whether to agree conduct a transaction with other party.

In some embodiments, the TSS may be used to assist a seller and a buyer of an item in conducting an in-person transaction to exchange the item and coordinate payment. The TSS may facilitate the payment using a debit card, a credit card, a payment service (e.g., PayPal), a bank transfer, and so on. Also, the monitor may also facilitate that payment as the monitor (e.g., a driver for a transportation service) may already be set up to handle debit or credit cards. The TSS may also be used for transactions that are not for the sale of an item. For example, a person who wants to hire a service provider (e.g., housekeeper) may use the TSS to arrange a meeting (i.e., the transaction) at a neutral location. In general, the TSS may be used to help ensure the security of any people meeting such as people using a dating service, estranged couples meeting, and so on. The TSS may also be used to help coordinate the meeting of groups of people such as an impromptu event for a social, charitable, political, or other cause.

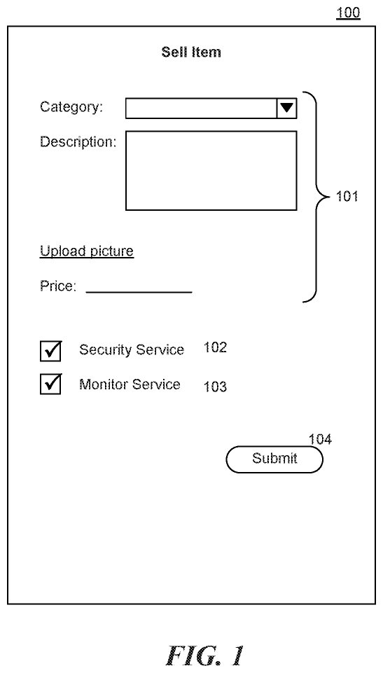

FIG. 1 is a diagram that illustrates a display page for listing an item to sell. A display page 100 includes item identification information 101, a security service checkbox 102, a monitor service checkbox 103, and a submit button 104. To sell an item, a seller enters identification information for describing the item to be sold and price for the item. The seller may also select whether the transaction to sell the item should be provided with a security service and/or a monitor service. By checking the security service checkbox, the seller indicates that the parties to the transaction will use the TSS to track the locations of the parties as they arrived at and depart from the transaction location. By checking the monitor service checkbox, the seller indicates that a monitor is to be provided for monitoring the transaction. The seller selects the submit button to submit the item for sale.

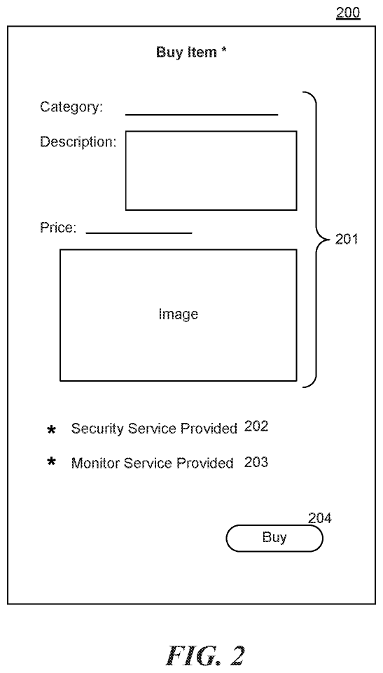

FIG. 2 is a diagram that illustrates a display page for reviewing items to that are for sale. A display page 200 includes identification information 201, a security service provided notification 202, a monitor service provided notification 203, and a buy button 204. The identification information describes an item that is for sale along with the price of the item. The security service provided notification indicates that the seller has requested that the TSS provide security for the transaction to sell the item. The monitor service provided notification indicates that the seller has requested that a monitor be provided for the transaction. A person who wants to purchase the item selects the buy button.

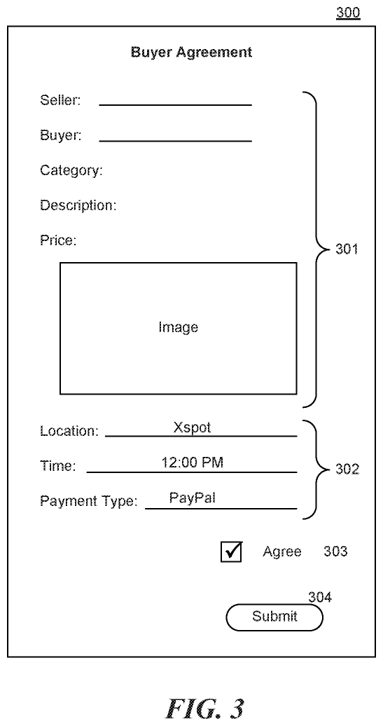

FIG. 3 is a diagram that illustrates a display page for agreeing to purchase an item. A display page 300 includes identification information 301, transaction information 302, an agree checkbox 303, and a submit button 304. The identification information describes the item to be purchased along with its price. The transaction information identifies the location and time of the transaction and may also identify the payment type for the transaction. Although not illustrated, the TSS or an advertisement service may allow the buyer and seller to exchange messages via email or instant messages to arrange a convenient time and location for the transaction. The seller may enter the agreed-upon time and location via a similar display page, and the buyer may be prompted by this display page to confirm the time and location and other terms of the transaction. To confirm the transaction, the buyer checks the agree checkbox and selects the submit button.

In some embodiments, the TSS may be used in conjunction with any advertisement service such as Craigslist, OfferUp, and LetGo for the sale of an item. In such a case, after the parties agree on the terms of the transaction including enabling security for the transaction and possibly the location and time of the transaction, one of the parties can register the transaction with the TSS. To register a transaction, a party may provide a link to the advertisement to the TSS, terms of the transaction, time and location of the transaction, electronic mail address of the other party, and so on. To provide the link, the party may copy the uniform resource locator (“URL”) from the address bar of the web page that displays the advertisement, copy the link from a reply message to be sent to the seller (e.g., with Craigslist), and so on. Once one party registers a transaction, the TSS sends an email to the other party requesting confirmation of the transaction as described above. The TSS may also allow the parties to coordinate the time and location of the transaction as part of registration and confirmation process.

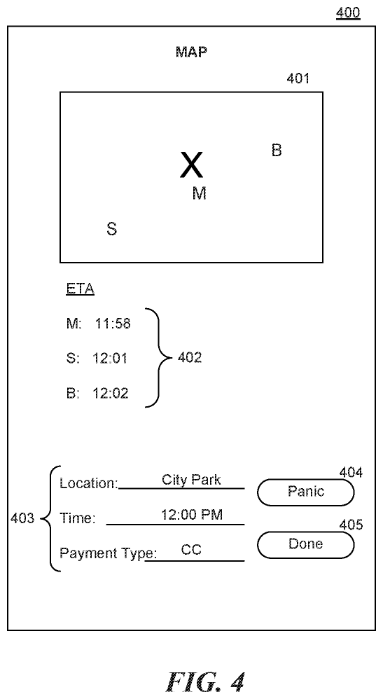

FIG. 4 is a diagram that illustrates a display page for tracking locations of parties to a monitored transaction. A display page 400 includes a map 401, an estimated time of arrival area 402, transaction information 403, a panic button 404, and a done button 405. The map, which may be provided by a map service (e.g., Google maps), shows the location of the transaction in the center of the map marked by an “X.” The map also shows the location of the seller “S,” the buyer “B,” and the monitor “M.” As the parties move to within the awareness zone, the TSS updates the map to indicate the location of each party. The estimated time of arrival area indicates the estimated time of arrival of each party, which is especially useful when a party is not within the awareness zone. The TSS may employ a map service to provide the estimated time of arrivals. The transaction information includes the time and location of the transaction along with an indication of the method of payment. If the panic button is selected, the TSS may send an alert to the TSS to provide assistance at the location. A party selects the done button to notify the TSS that the transaction is complete. If the transaction is monitored, then the TSS may use the selection of the done button by the monitor to indicate that the transaction is complete. If not monitored, the TSS may use the selection of the done button by both the buyer and seller to indicate that the transaction is complete. In some embodiments, the panic button may be positioned away from the done button to prevent accidental pressing of the panic button. For example, the panic button may be positioned at the top of the display page.

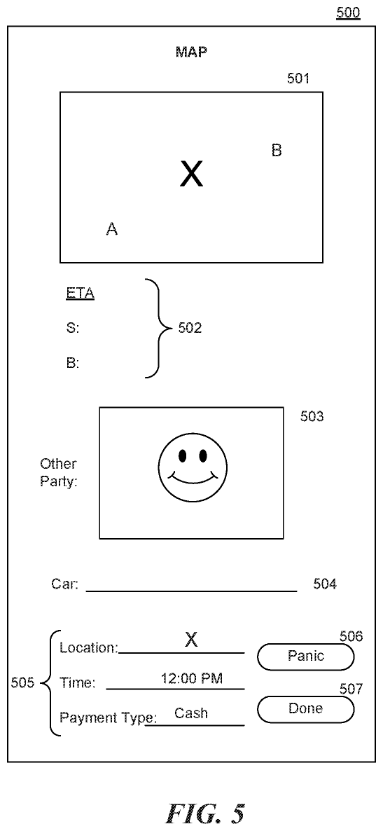

FIG. 5 is a diagram that illustrates a display page for tracking the locations of parties to a non-monitor transaction. A display page 500 includes a map 501, an estimated time of arrival area 502, an other party photo area 503, an other party car area 504, transaction information 505, the panic button 506, and a done button 507. Display page 500 is similar to display page 400 except that it is for a non-monitored the transaction and that it displays a photograph of the other party and a description of the car of the other party to help in identifying the other party.

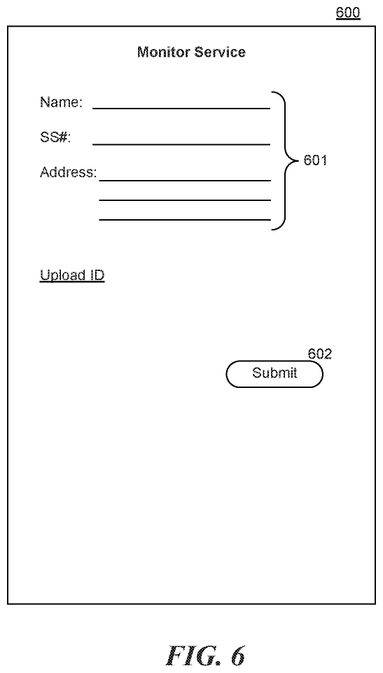

FIG. 6 is a diagram that illustrates a display page for a person to sign up as a monitor. A display page 600 includes monitor identification information area 601 and a submit button 602. A person may use the display page to enter their identification information, which may include their name social security number address and along with a photograph and optionally biometric information. The person then presses the submit button to enter their request to be a monitor. The TSS then conducts verification of the person prior to assigning the person to be a monitor for a transaction. As discussed above, the TSS may interface with a transportation service to request drivers signed up with that transportation service to monitor the transactions. When the time of the transaction is approaching, the TSS may request the transportation service to identify nearby drivers who are available to monitor the transaction. Once a nearby driver is selected, the TSS tracks the location of the driver as the driver arrives at the location of the transaction. The TSS may coordinate the compensation of monitors for their services. An advertisement service may factor in whether a transaction uses the security service or the monitor service in determining price for using the advertisement service. The price may be paid by a buyer or a seller or both.

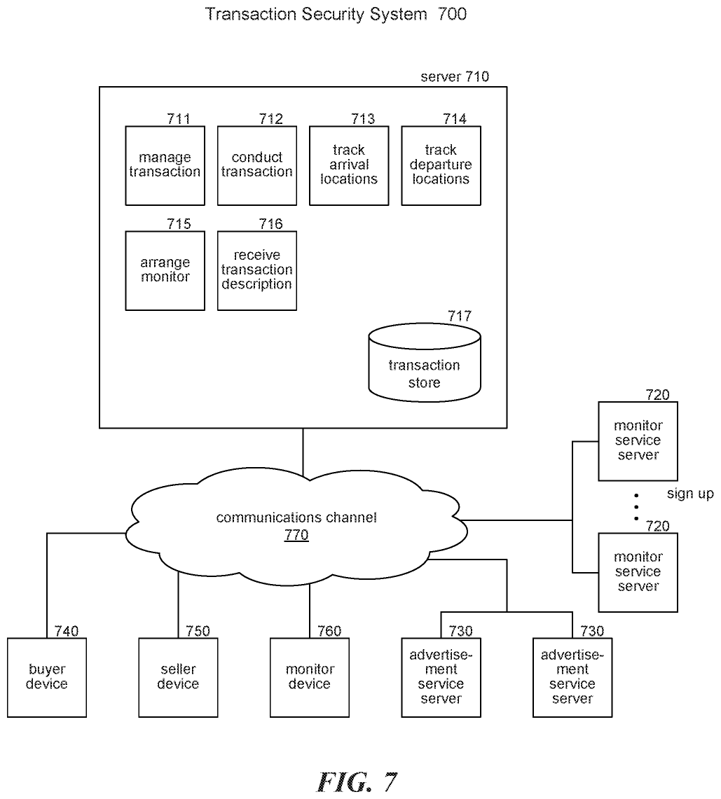

FIG. 7 is a block diagram that illustrates components of a transaction security system in some embodiments. A transaction security system 700 includes a server 710 that interfaces with monitor service servers 720, advertisement service servers 730, buyer devices 740, seller devices 750, and monitor devices 760 via a communications channel 770. The transaction security system also includes client components, such as applications, that execute on the buyer devices, seller devices, and monitor devices. The server 710 includes a manage transaction component 711, a conduct transaction component 712, a track arrival locations component 713, a track departure locations component 714, an arrange monitor component 715, and a receive transaction description component 716. The server also includes a transaction store 717 for storing descriptions of transactions. The manage transaction component controls the management of a transaction by invoking the track arrivals locations component, the conduct transaction component, and the track departure locations component. The arrange monitor component is invoked to control the arranging of a monitor for a transaction via a monitor service server. The receive transaction description component is invoked to receive transaction descriptions from advertisement services and store the transaction descriptions in the transaction store. The buyer devices, the seller devices, and the monitor devices may be mobile devices (e.g., smartphones) executing applications of the TSS. The applications may access the location services of the mobile devices (e.g., GPS service) to track the location of the parties. The communications channel may be a cellular communication channel, the Internet, or some other communications channel.

The computing devices and systems on which the TSS may be implemented may include a central processing unit, input devices, output devices (e.g., display devices and speakers), storage devices (e.g., memory and disk drives), network interfaces, graphics processing units, and so on. The input devices may include keyboards, pointing devices, touch screens, gesture recognition devices (e.g., for air gestures), head and eye tracking devices, microphones for voice recognition, and so on. The computing devices may access computer-readable mediums that include computer-readable storage mediums and data transmission mediums. The computer-readable storage mediums are tangible storage means that do not include a transitory, propagating signal. Examples of computer-readable storage mediums include memory such as primary memory, cache memory, and secondary memory (e.g., DVD) and include other storage means. The computer-readable storage mediums may have recorded upon or may be encoded with computer-executable instructions or logic that implements the prioritization system. The data transmission medium is media for transmitting data using transitory, propagating signals or carrier waves (e.g., electromagnetism) via a wire or wireless connection.

The TSS may be described in the general context of computer-executable instructions, such as program modules and components, executed by one or more computers, processors, or other devices. Generally, program modules or components include routines, programs, objects, data structures, and so on, that perform particular tasks or implement particular data types. Typically, the functionality of the program modules may be combined or distributed as desired in various embodiments. For example, certain components described as being implemented on the server may be implemented on client application executing on a mobile device of a party. The TSS may be implemented on a data center Aspects of the TSS may be implemented in hardware using, for example, an application-specific integrated circuit (“ASIC”).

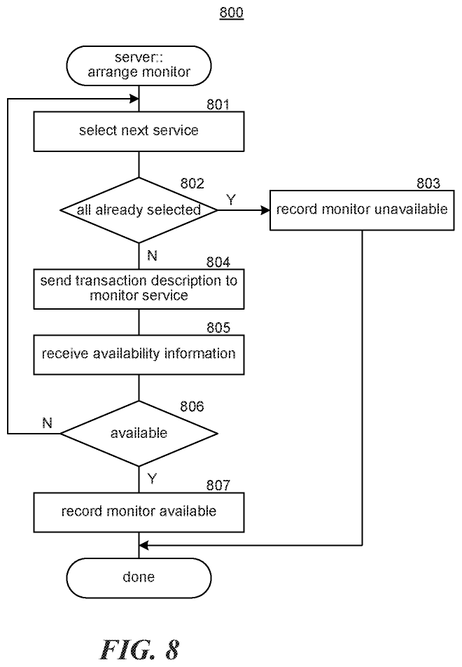

FIG. 8 is a flow diagram that illustrates the processing of an arrange monitor component of a server in some embodiments. An arrange monitor component 800 is invoked to arrange a monitor for a transaction in which a monitor service has been requested. In block 801, the component selects the next monitor service. In decision block 802, if all the monitor services have already been selected, then no monitor service is available to monitor the transaction and the component continues at block 803, else the component continues at block 804. In block 803, the component records an indication that no monitor is available for the transaction completes. The parties may also be notified so that they can decide whether to proceed with, cancel, postpone, or otherwise change the transaction. In block 804, the component sends a transaction description to the monitor service. In block 805, the component receives availability information from the monitor service. In decision block 806, if a monitor is available from the selected monitor service, then the component continues at block 807, else the component loops to block 8012 select the next monitor service. In block 807, the component records information describing that the monitor is available as part of the transaction description that is stored in the transaction store and completes. A monitor may be assigned well in advance of a transaction or may be assigned at the time of the transaction, for example, if a nearby driver is to monitor the transaction.

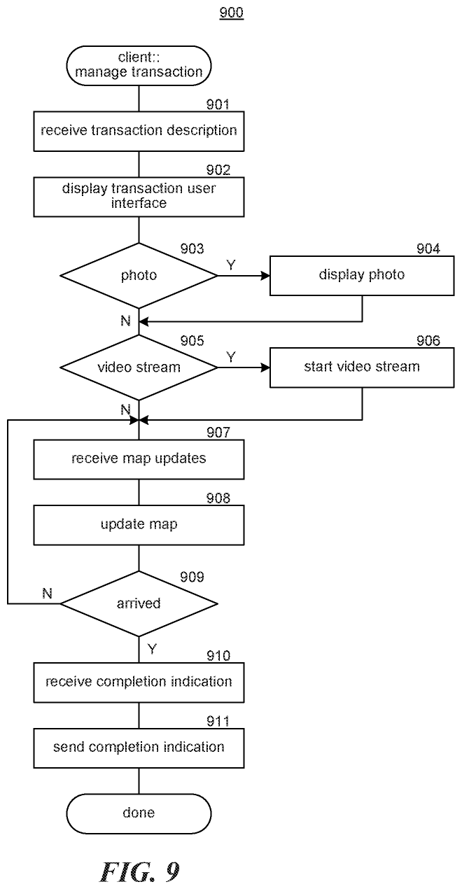

FIG. 9 is a flow diagram that illustrates the processing of a manage transaction component of a client in some embodiments. A managed transactions component 900 executes on the device of a party to a transaction to coordinate a transaction. In block 901, the component receives from the server a transaction description. In block 902, the component displays a transaction user interface (e.g., display page 400 or 500). In decision block 903, if a photograph of another party is to be displayed, the component displays the photograph in block 904. In decision block 905, if a video stream of the transaction is to be collected, then the component starts the video stream in block 906. In blocks 907-909, the component loops updating the map of the transaction user interface to indicate the locations of the parties. In block 907, the component receives map update information from the server. In block 908, the component updates the map to indicate the updated locations of the parties. In decision block 909, if the parties are determined to have arrived at the location of the transaction, then the component continues at block 910, else the component loops to block 907. In block 910, the component receives a completion indication from the user of the device. In block 911, the component sends a completion indication to the server and then completes. Although not illustrated, the application executing on the device of a party may include a panic button. When the panic button is pressed, the application then takes measures to help ensure the security of the party who pressed the panic button.

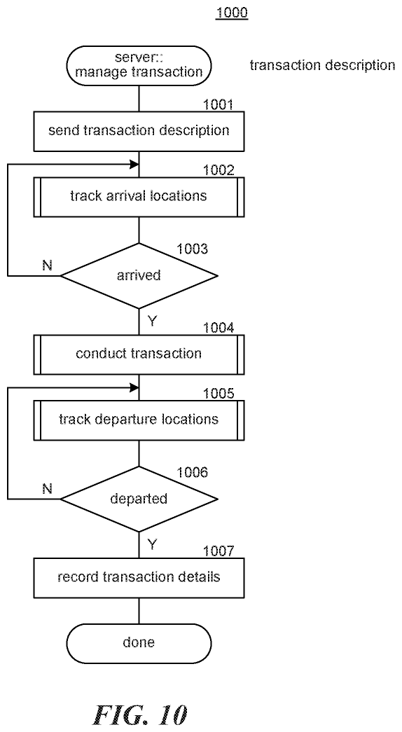

FIG. 10 is a flow diagram that illustrates the processing of a manage transaction component of a server in some embodiments. A managed transaction component 1000 is provided a transaction description and coordinates the managing of the transaction. In block 1001, the component sends the transaction description to the devices of the parties. In blocks 1002-1003, the component tracks the locations of the arriving parties. In block 1002, the component invokes a track arrival locations component to collect the current locations of the parties. In decision block 1003, if the parties have arrived, then the component continues at block 1004, else the component loops to block 1002. In block 1004, the component invokes a conduct transaction component to conduct the transaction. In blocks 1005-1006, the component loops tracking the departure locations of the parties. In block 1005, the component invokes a track departure locations component to track the current location of each party. In decision block 1006, if the parties have departed from the location of the transaction, then the component continues at block 1006, else the component loops to block 1005. The parties may have been determined to have arrived or departed from the location of the transaction based on various criteria. For example, the parties may manually indicate that they have arrived, the location of the parties may be used to determine whether they are within an arrival distance from the location of the transaction, and so on. In block 1006, the component updates the transaction description of the transaction store to reflect the details of the transaction and then completes.

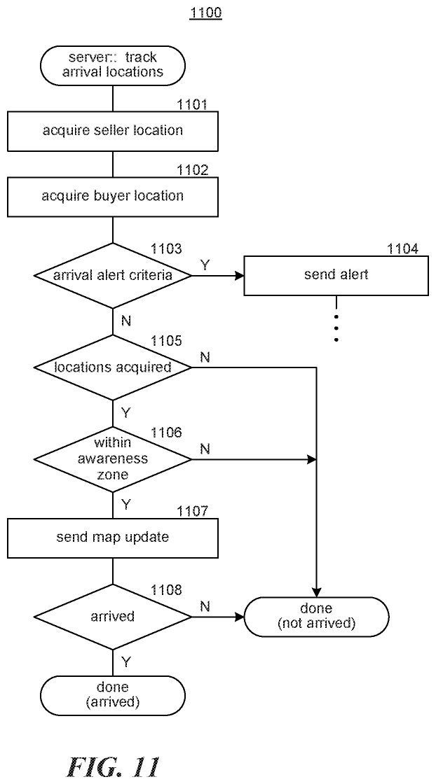

FIG. 11 is a flow diagram that illustrates the processing of a track arrival locations component of a server in some embodiments. A track arrival locations component 1100 is invoked to track the current location of the parties. In blocks 1101-1102, the component acquires the location of the buyer and seller and may also acquire the location of the monitor if the transaction is monitored. The locations may be acquired by requesting and receiving location information from an application executing on the devices of the parties. In decision block 1103, if an alert criterion is satisfied, then the component continues at block 1104, else the component continues at block 1105. An alert criterion might be satisfied, for example, if it appears one party is following another party based on their location information. The alert may indicate to one of the parties to change their route to location of the transaction to see if another party follows. The alert may also suggest that one of the parties to abandon the transaction. The server may also stop providing further location information to a party that appears to be following the other party. Although not illustrated, after sending an alert, the component may take other measures to ensure the security of the parties such as notifying police. In decision block 1105, if the location of all the parties have been acquired, then the component continues at block 1106, else the component completes indicating that the parties have not arrived. In decision block 1106, if all the parties are within an awareness zone, then the component continues at block 1107, else the component completes indicating that the parties have not arrived. In block 1107, the component sends an update to the application executing on the devices of the parties to indicate the locations of the parties. Alternatively, the component may send an update to the applications whenever at least one party is within the awareness zone. In decision block 1108, if all the parties have arrived, then the component completes indicating that the parties have arrived, else the component completes indicating that the parties have not arrived.

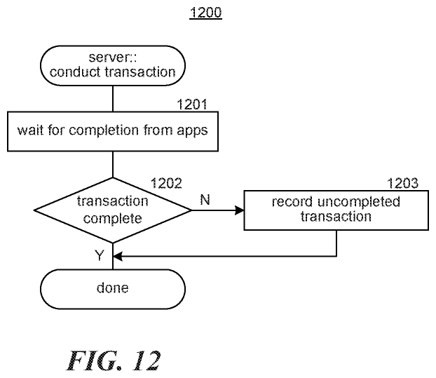

FIG. 12 is a flow diagram that illustrates the processing of a conduct transaction component of a server in some embodiments. A conduct transaction component 1200 is invoked to conduct a transaction after the parties have arrived. In block 1201, the component waits for a notification of completion from the applications of the devices of the party. In decision block 1202, if the transaction is indicated as being complete, then the component completes, else the component continues at block 1203. In block 1203, the component records in the transaction description of the transaction store an indication that the transaction is uncompleted.

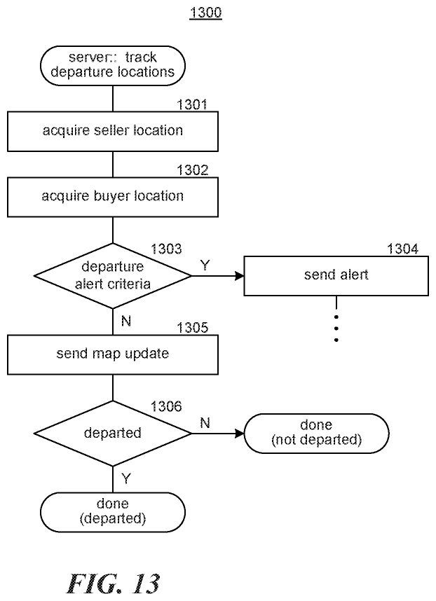

FIG. 13 is a flow diagram that illustrates processing of a track departure locations of the server in some embodiments. A track departure locations 1300 component is invoked to track the departure of the parties after a transaction is completed or otherwise has ended. In blocks 1301-1302, the component acquires the locations of the parties to the transaction. In decision block 1303, if a departure alert criterion is satisfied, then the component continues at block 1304, else the component continues at block 1305. In block 1304, the component sends an alert indicating that security of a party may be in jeopardy. The departure alert criterion may be satisfied when it appears that one party is following another party. In block 1305, the component sends a map update to the applications of the devices of the parties. In decision block 1306, if the parties have departed from the location of the transaction, then the component completes indicating that the parties have departed, else the component completes indicating that the parties have not yet departed.

Although the subject matter has been described in language specific to structural features and/or acts, it is to be understood that the subject matter defined in the appended claims is not necessarily limited to the specific features or acts described above. Rather, the specific features and acts described above are disclosed as example forms that implement the claims. Accordingly, the invention is not limited except as by the appended claims.

I/we claim:

1. A method performed by a computing system for managing a transaction, the method comprising:
receiving a transaction description that identifies the parties o the transaction and time and location of the transaction;
tracking the locations of the parties to the transaction starting prior to the time of the transaction and ending after the transaction has been completed;
providing to each party an indication of tracked locations of at least one other party to the transaction so that a party may know the tracked location of another party;
receiving from a party an indication that the transaction is complete; and
recording an indication that the transaction is complete.

2. The method of claim 1 wherein the parties to the transaction include a buyer and a seller.

3. The method of claim 1 wherein the parties to the transaction include a monitor.

4. The method of claim 3 wherein the monitor is responsible for monitoring the transaction.

5. The method of claim 3 further comprising contacting a transportation service to identify a driver who is available to serve as the monitor.

6. The method of claim 1 wherein the tracking of the locations of the parties include receiving location information gathered from a device of each party.

7. The method of claim 1 wherein the indications of tracked locations are provided to a party when a party is within an awareness zone that encompasses the location of the transaction.

8. The method of claim 6 wherein the awareness zone is specified by a radius centered on the location of the transaction.

9. The method of claim 1 wherein the transaction description is received from an advertisement service through which a party to the transaction posted an advertisement.

10. The method of claim 1 further comprising receiving an indication from a party that the transaction is not secure and in response to receiving the indication that the transaction is not secure, alerting a security service of the location of the transaction.

11. The method of claim 10 wherein the security service is a police department.

12. The method of claim 1 further comprising receiving from a party a video stream of the transaction.

13. The method of claim 1 further comprising monitoring the locations of the parties to ensure that one party does not follow another party.

14. The method of claim 1 further comprising receiving a message from one party and transmitting the message to another party.

15. The method of claim 1 wherein each party has a mobile device.
